(19) United States
(12) Patent Application Publication
(10) Pub. No.: US 2002/0147570 A1
(43) Pub. Date: Oct. 10, 2002

(54) System and method for monitoring the interaction of randomly selected users with a web domain

(76) Inventors: Timothy Kraft, Del Mar, CA (US); Oran M. Thomas, Carlsbad, CA (US)

Correspondence Address: Kevin J. Zimmer, Cooley Godward LLP, Five Palo Alto Square, 3000 El Camino Real, Palo Alto, CA, 94306-2155, US

(21) Appl. No.: 09/832,434

(22) Filed: Apr. 10, 2001

(51) Int. Cl. G06F 15/00

(52) U.S. Cl. 702/186

(57) ABSTRACT

A method for monitoring usage of a web browser during interaction with a content server is disclosed herein. The method includes the step of determining whether a user identification code associated with the web browser indicates that the web browser is included within a sampled population of web browsers interacting with the content server. Usage data indicative of the interaction is generated upon determining that the web browser is a member of the sampled population. The usage data is then transmitted for storage and retrieval at a remote location.

### FIELD OF THE INVENTION

This invention relates to a system for monitoring usage of computers and other electronic devices, and, more particularly, to a system for monitoring interaction of randomly selected users with particular domains of the World Wide Web (“WWW”) of computers.

### BACKGROUND OF THE INVENTION

The amount of information accessible to end users via the World Wide Web (“WWW”) has continued to dramatically increase. However, unlike the relatively controlled environment characteristic of private computer networks, it has proven rather difficult to monitor interaction with network resources on public networks such as the WWW.

The techniques utilized in many private networks for monitoring client use and interaction do not lend themselves to public networks. For example, user access to a server in private networks is generally obtained through the use of a unique identification number provided by the server. Details of individual user interaction with the network are closely monitored by server-resident processes, and historic databases are automatically generated and continually updated to track the nature and amount of information accessed by individual users, as well as their connection time. This information has generally been used, for example, to maintain a subscriber-indexed billing database.

A number of techniques are currently employed to collect information relating to such interaction. One such technique is the voluntary registration process, which involves a user providing personal information in exchange for access to otherwise restricted media content offered through a site on the WWW (a “Web site”). After a voluntary registration process has been completed, an authentication process is employed during subsequent visits to the same Web site. In the subsequent visit, the user is permitted to circumvent the registration process by entering a user name and password. Once the user enters this information, the server computer hosting the Web site recognizes the user and tracks the user's interaction with Web pages served by the site. However, the use of authentication has become disfavored, since it requires users to remember a user name and password for each site requiring authentication.

Another mechanism for collecting information relating to user interaction with Web sites relies upon “mining” of the log files of server computers. Such log files are typically compiled through a mechanism formally referred to as persistent client-side state, and informally referred to as “cookies”. Persistent client-side state permits the server computer hosting a site to store and retrieve information within the web browser that a client computer uses to access the site. The server computer hosting the site for user tracking and other purposes can then use the information. In particular, the server stores a unique value in each browser's cookie and makes a corresponding entry in its log file for that value. The server then records the cookie associated with each browser request made to the applicable Web site, thereby creating a log file associated with the site. Information relating to user interaction with the site may then be obtained by analyzing the log file.

Unfortunately, detailed evaluation of the voluminous log files associated with Web sites serving large number of Web pages to large numbers of users can become prohibitively expensive. Moreover, log files tend to inaccurately reflect user behavior in a number of respects. For example, it has been shown that significant percentages of Web pages viewed by users have been cached by the user's browser or an intermediary proxy server. Because such cached Web pages are not re-served by the applicable server upon being viewed, such views are not registered in the server's log file. In addition, log files are typically incapable of being used to discriminate between viewing of Web pages by actual visitors and “views” corresponding to automated interaction with the site through, for example, robots or “spiders”. In addition, log files typically fail to distinguish between visits to a Web page and the constituent “frames” which may comprise the page.

Accordingly, it would be highly desirable to perform economical and accurate tracking of user viewing of the Web pages provided by particular Web sites.

### SUMMARY OF THE INVENTION

In summary, the present invention pertains to a method for monitoring usage of a web browser during interaction with a content server. The method includes the step of determining whether a user identification code associated with the web browser indicates that the web browser is a member of a sampled population of web browsers interacting with the content server. Usage data indicative of the interaction is generated upon determining that the web browser is a member of the sampled population. The usage data is then transmitted, received at a remote location, and stored.

The inventive method also preferably includes the step of determining whether any persistent client-side state information associated with the web browser includes identification information suitable for use as the user identification code. In the event such suitable identification information is not found to exist, a random number corresponding to the user identification code is generated. The random number may be appended to preexisting client-side state information associated with the web browser, or may be separately associated with the web browser as additional client-side state information.

In another aspect, the present invention relates to a system for monitoring usage of a web browser executing on a client computer during interaction with a content server. The system includes a client component for determining whether a user identification code associated with the web browser indicates that the web browser is a member of a sampled population of web browsers interacting with the content server. In the event the web browser is found to be a member of the sampled population, usage data indicative of the interaction is generated and transmitted to a monitoring sever at a remote location.

### BRIEF DESCRIPTION OF THE DRAWINGS

For a better understanding of the nature of the features of the invention, reference should be made to the following detailed description taken in conjunction with the accompanying drawings, in which:

FIG. 1 illustratively represents a client-server computer network within which may be incorporated a preferred embodiment of the present invention.

FIG. 2 is a flow chart illustrating the processing steps involved in monitoring a population of users in accordance with the statistical sampling techniques of the present invention.

FIG. 3 is a flow chart illustrating the processing steps involved in monitoring a statistically sampled population of users that have refrained from disabling the use of cookies on their respective client computers.

### DETAILED DESCRIPTION OF THE INVENTION

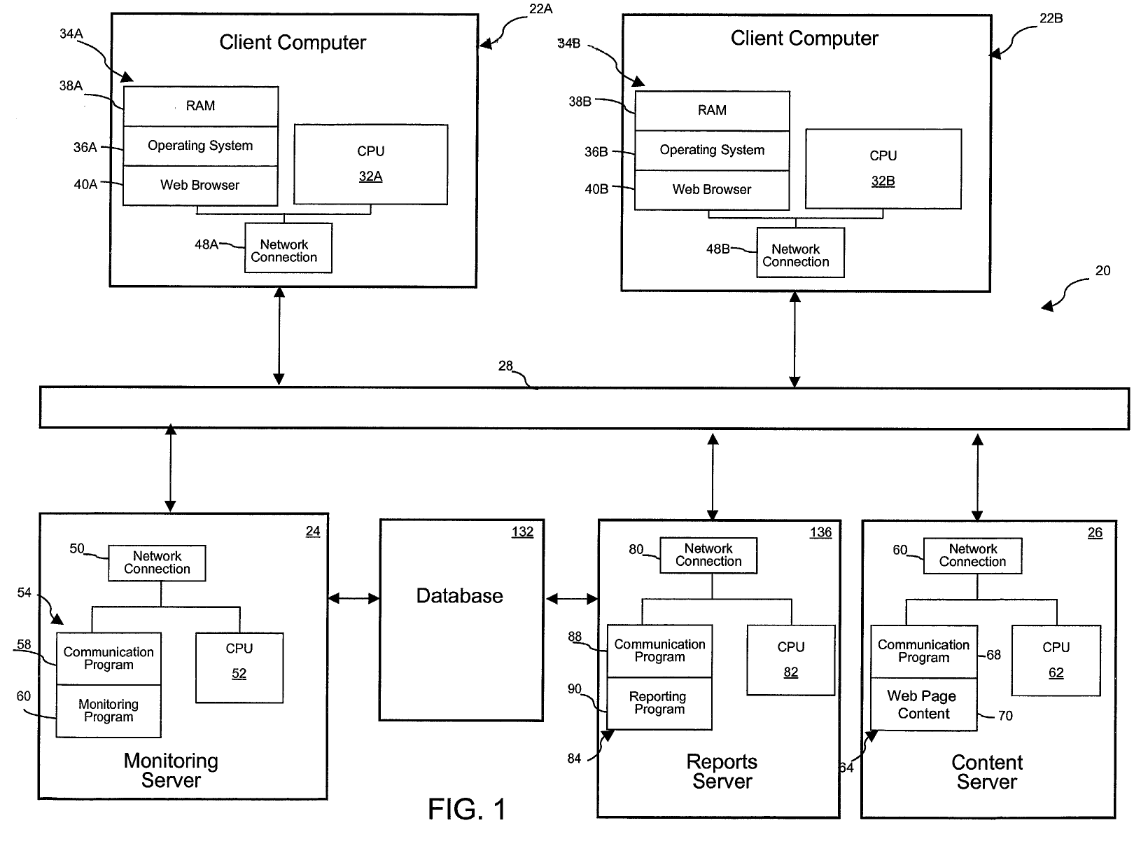

FIG. 1 illustratively represents a client-server computer network 20 within which may be incorporated a preferred embodiment of the present invention. The computer network 20 may be considered a simplified representation of a local area network, wide area network, or the WWW. The network 20 includes a number of client computers 22 disposed for communication with a monitoring server 24 and a content server 26 through a transmission channel 28, which may be any wire or wireless transmission channel. As is described below, the monitoring server 24 is operative to monitor the interaction between one or more web sites hosted by the content server 26 and a randomly selected group of web browsers executing on associated ones of the client computers 22.

Each client computer 22 preferably includes a central processing unit (“CPU”) 32 and a memory subsystem 34. The memory subsystem 34 holds a copy of the operating system 36 for the client computer 22. Also included within the memory subsystem 34 are RAM 38 and a web browser 40, which executes on the CPU 32. Each of the client computers 22 need not have this configuration, and this configuration is intended to be merely illustrative. As is known in the art, the web browser 40 may be used to communicate with the content server 26. The client computer 22 establishes network communications through a standard network communication device 48.

The monitoring server 24 includes standard server computer components, including a network connection device 50, a CPU 52, and a memory (primary and/or secondary) 54. The memory 54 stores a standard communication program 58 to realize standard network communications. The memory 54 also stores a client monitoring program 60, which receives usage data provided by a random sampling of those client computers 22 requesting Web pages from the content server 26. As used herein, the term “random” and its variants shall be construed to include pseudorandom and other sampling processes described herein. As will be discussed below, the monitoring of randomly selected ones of the client computers 22 advantageously enables statistics representative of client interaction with the content server 26 to be obtained without tracking the interaction of all client computers 22 communicating with the content server 26. Such usage statistics are stored by the monitoring server 24 in a database 132.

The content server 26 has a physical configuration similar to that of the monitoring server 24, including a network connection circuit 60, a CPU 62, and a memory 64. The memory 64 stores a standard communication program 68 to realize standard network communications. The memory 64 also includes a web page content module 70, which stores the content used in generating and serving Web pages in response to requests from client computers 22.

A reports server 136 is also similarly configured to the monitoring server 24, and includes a network connection circuit 80, a CPU 82, and a memory 84. The memory 84 stores a standard communication program 88 to realize standard network communications. The memory 84 also includes a reporting program 90, which retrieves usage statistics from the database 132 in response to standard database queries from the operator (not shown) of the content server 26.

Attention is now directed to copending U.S. patent application Ser. No. 09/587,236, entitled SYSTEM AND METHOD FOR MONITORING USER INTERACTION WITH WEB PAGES, which is hereby incorporated by reference in its entirety. This copending patent application describes a methodology of monitoring the behavior of the users interacting with a particular site on the WWW which, for purposes of comparison, will be described as being implemented within the network 20 of FIG. 1. In accordance with this methodology, content server 26 would embed a script tag within the body of an HTML page sent to a client computer 22 issuing a TCP/IP request thereto. Upon loading of the HTML page into the browser 40 executing on the client computer 22, the script tag would request the browser 40 to load an instrumentation script from the monitoring server 24. The instrumentation script would then monitor user interaction with the HTML page by recording information relating to various indicia of user interaction (e.g., time spent viewing the page, mouse events, keyboard events, and the identity of selected hyperlinks). The usage data collected by the instrumentation script would then be transmitted by the client computer 22, via the network 28, to the monitoring server 24 for further processing.

In contrast to the methodology of the above-referenced patent application, the present invention contemplates that an instrumentation or data collection script be downloaded only to a randomly selected population of users interacting with a particular Web site. That is, the data collection script is not automatically requested from the content server 26 upon downloading of a tagged HTML page from the content server 26 to a browser 40. Instead, only HTML pages provided to web browsers 40 within the randomly selected set are instrumented with the data collection script from the monitoring server 24. This approach enables meaningful trends in user behavior to be discerned through analysis of only a fraction of the usage data that would otherwise be collected by the monitoring server 24. In addition, this technique advantageously reduces the cost of collecting and processing such usage data and preserves user anonymity relative to other methods by tracking the behavior of a relatively fewer number of users.

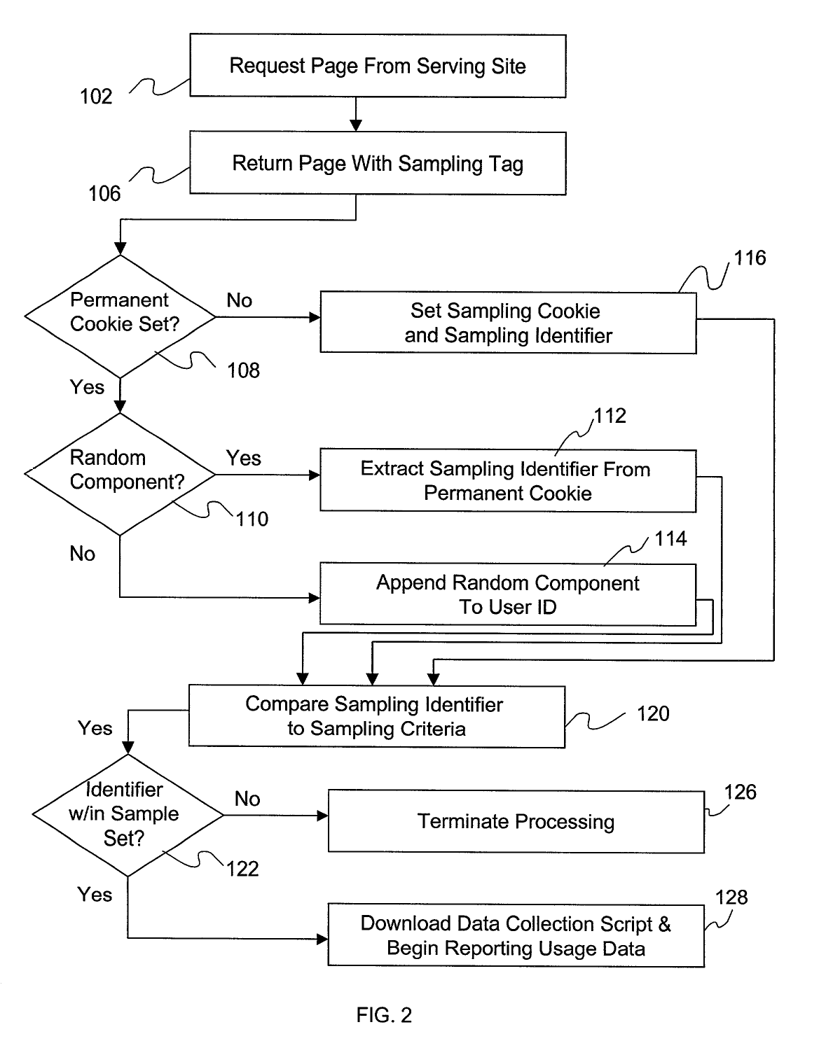

FIG. 2 is a flow chart illustrating the processing steps involved in monitoring a population of users in accordance with the statistical sampling techniques of the present invention. The first processing step is for the web browser 40 of a particular client computer 22 to request a page of information from the content server 26 in accordance with known techniques (step 102). The content server 26 receives the request and returns the requested HTML page together with an embedded sampling tag (step 106). In a preferred implementation the sampling tag is comprised of a scripting language (e.g., JavaScript), and is identified within the body of the HTML page by a <SCRIPT> tag. If the sampling tag determines that the content server 26 has set a permanent cookie (step 108), then the sampling tag reads the identifier value from the “User-ID” portion of the permanent cookie. If the sampling tag determines that this identifier value includes a random component (e.g., a time value or assigned user number) (step 110), then this random component is extracted and designated as a sampling identifier to be used in determining whether the activity of the web browser 40 will be monitored (step 112). For example, an exemplary User-ID may comprise the alphanumeric string “User-ID=ANDK-KL8999-18903”. If the sampling tag determines that a portion of this string (e.g., “18903”) represents a random value, then this value would be extracted and used as the sampling identifier pursuant to step 112. If the sampling tag determines that no portion of the User-ID includes a random component, then the sampling tag may append such a random component (step 114) to the User-ID as follows:

User-ID=ANDK-KL8999-18903-90801798276912

or, alternatively,

User-ID=ANDK-KL8999-18903 &sample=90801798276912

where in each case the appended string “90801798276912” corresponds to the sampling identifier.

If the sampling tag determines that the content server has not set a permanent cookie (step 108), then the sampling tag sets a permanent sampling cookie within the client computer 22 (step 114). The sampling tag sets the domain of the sampling cookie so as to render it viewable by the monitoring server 24. In addition, the sampling tag generates a random number corresponding to the sampling identifier (e.g., KLUser-Sample=90801798276912) and includes this value within the sampling cookie (step 116). In an alternate implementation the sampling tag simply sets a permanent sampling cookie irrespective of whether the content server 26 has independently set a permanent cookie on the client computer 22. However, this approach may be less preferred in instances when the operator of the content server 26 desires to limit the number of cookies set on a given client computer 22. In any event, the cookie including the sampling identifier is preferably permanently instantiated on the client computer 22 in order to permit usage data to be collected across different user sessions with the content server 26.

Once the sampling tag has identified or created a sampling identifier as described above, the sampling tag determines whether such identifier is included within the set of sampling identifiers defining the sampled population to be monitored (step 120). For example, if it were desired to monitor the behavior of 10% of the users requesting pages from the content server 26, then the sampled population could include all sampling identifiers having a value divisible by the integer 10. If the sampling tag determines that the sampling identifier is a member of the sampled population (step 122), the sampling tag requests via the web browser 40 that a data collection script be downloaded from the monitoring server 24. The data collection script then instruments the HTML page loaded into the browser and begins reporting usage statistics to the -monitoring server 24 in the manner described within the above-referenced copending patent application (step 128). Processing is terminated if the sampling tag determines that the sampling identifier is not included within the sampled population (step 126).

As mentioned above, such usage statistics are compiled within the database 132 and are made accessible to the reports server 136. As part of this compilation process, the collected usage statistics will typically be scaled in accordance with the applicable sampling rate. For example, if 10% of the users requesting pages from the content server 26 were monitored, then the collected data would be appropriately scaled by a factor of ten. The database 132 is conventionally interrogated by the reports server 136 in response to queries submitted to the reports server 136 by the operator of the content server 26.

The processing described with reference to FIG. 2 presumes that all users requesting pages from the content server 26 have enabled the setting of cookies on their respective client computers 22. A number of possible approaches may be employed with respect to those client computers 26 that have disabled the setting of cookies. Given that the disabling of cookies may evince a heightened concern for privacy, the sampling tag may be configured to simply not include any users within the sampled population which have so disabled cookies (“cookies-off users”). In a second approach, the sampling tag may be configured to request data collection scripts from the monitoring server 24 for all client computers 26 associated with cookies-off users. This second approach avoids the underreporting of cookies-off users potentially arising under the first approach, but could result in a disproportionate representation of cookies-off users within the sampled population. Such disproportionate representation could at least in part be obviated by providing data collection scripts to only a predefined percentage of the client computers 26 associated with cookies-off users. Finally, data collection could be carried out with respect to all cookies-off users. However, such users would not be considered part of the sampled population if this approach is followed, and the resultant usage statistics would typically be segregated within the database 132 and separately reported by the reports server 136.

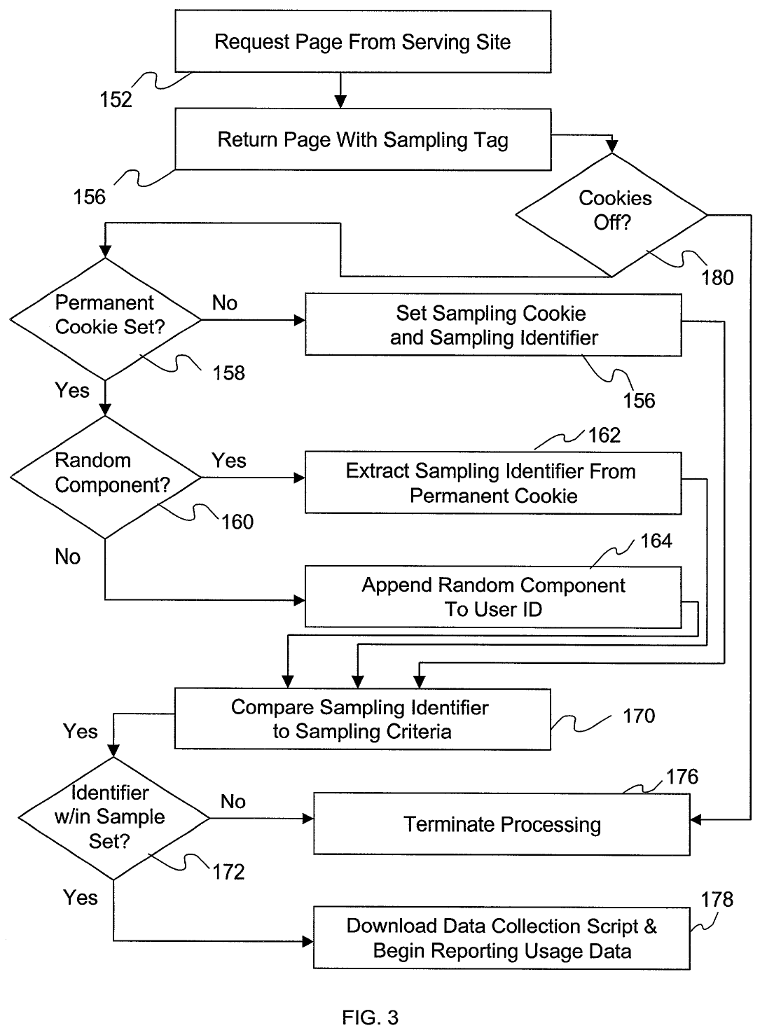

FIG. 3 is a flow chart illustrating the processing steps involved in monitoring a statistically sampled population of users that have refrained from disabling the use of cookies on their respective client computers. In the flow chart of FIG. 3, the processing steps 152-178 are consistent with the processing steps 102-128 of FIG. 2. However, in FIG. 3, the processing step 180 is performed in order to exclude cookies-off users from the sampled population. Specifically, in step 180 the sampling tag determines whether the subject client computer 22 has disabled the setting of cookies. If so, processing terminates and the sampling tag refrains from requesting that a data collection script be provided to the client computer 22 (step 176). If cookies have not been disabled, processing proceeds with step 158 in the manner described above.

It will be appreciated that it may be desired to vary the percentage of the users sampled among the various web pages served by the content server 26. For example, in certain instances reporting accuracy could be enhanced by sampling a larger percentage of the user interactions with infrequently visited pages relative to more highly requested pages. Such stratification in sampling rate could be effected by appropriately configuring the sampling tag embedded within each page served by the content server 26. As an example, the sampling tags embedded into certain infrequently requested pages could specify a sampling rate of 10% (e.g., by selecting for monitoring only those client computers 22 associated with sampling identifiers divisible by 10) while the tags embedded in more popular pages could establish a lower sampling rate of 1%. Although usage of different web pages served by content server 26 may be sampled at different sampling rates so as to produce a set of stratified user samplings, it is nonetheless possible for the reports server 136 to generate reports based upon a uniform sampling percentage that is less than or equal to the lowest applicable sampling rate. For example, again consider the case in which a pair of stratified user samplings are generated by sampling infrequently requested web pages at a rate of 10% and more popular pages at a rate of 1%. In this case the reports server 136 could produce a “rollup” report based upon a sampling rate of 1% by extracting 10% of the usage data collected from the infrequently requested web pages and 100% of the data collected from the more popular web pages. This extracted data would then be scaled by the reports server 136 based upon the applicable sampling percentage (i.e., 1%) in order to generate the rollup report.

Web site operators may also desire to differently track various types of users visiting a particular Web site. For example, it may be preferred to track a higher percentage of users identified by the operator of content server 26 as frequent visitors to a particular site relative to those users which merely occasionally browse the site (e.g., “power users” and “browsers”, respectively). Similarly, Web site operators may want to track the behavior of a higher percentage of those users purchasing products from a site relative to those electing not to do so. In each case this tracking may be effected by defining distinct stratified user samplings. Specifically, at least two distinct stratified user samplings or populations are defined and a different sampling percentage is associated with each such population. This requires an implementation of the sampling tag capable of (i) identifying the user population to which a given user requesting a page from the content server 26 belongs, and (ii) determining, in accordance with the applicable sampling rate, whether such user is to be included in the sampled population culled from such population. The sampling tag provides an indication of the identity of the relevant user population (e.g., “power user”) to the data collection script, which includes this identification information with each set of usage data reported to the monitoring server 24. In this way usage statistics for a number of different user populations may be compiled within the database 132 with respect to each site monitored by the monitoring server 24.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

What is claimed is:

1. A system for monitoring usage of a web browser executing on a client computer during interaction with a content server, said system comprising:
a client component for determining whether a user identification code associated with said web browser indicates that said web browser is within a sampled population and for transmitting usage data indicative of said interaction in the event said web browser is included within said sampled population wherein said sampled population comprises a subset of a set of web browsers interacting with said content server; and
a monitoring server for receiving said usage data transmitted by said client component.

2. The system of claim 1 wherein said user identification code is stored on said client computer as persistent client-side state information.

3. The system of claim 1 wherein said client component includes a sampling tag embedded within a web page provided to said web browser by said content server, said sampling tag determining whether persistent client-side state information stored on said client computer includes identification information suitable for use as said user identification code.

4. The system of claim 3 wherein said sampling tag generates a random number corresponding to said user identification code in the event said identification information is determined to be unsuitable for use as said user identification code.

5. The system of claim 4 wherein said random number is appended to said persistent client-side state information and thereby stored on said client computer as said user identification code.

6. The system of claim 3 wherein said client component further includes a data collection script, said sampling tag requesting said data collection script to be downloaded from said monitoring server to said client computer in the event that said user identification code indicates that said web browser is included within said sampled population.

7. The system of claim 3 wherein said random number is stored on said client computer as said user identification code in the form of a sampling cookie distinct from said persistent client-side state information, said sampling tag determining whether said user identification code indicates that said web browser is included within said sampled population.

8. A system for monitoring usage of first and second web browsers during interaction with a content server, said first and second web servers executing on first and second client computers, respectively, said system comprising:
a transmission channel;
a first client component communicatively coupled to said transmission channel, said first client component determining whether a first user identification code associated with said first web browser indicates that said first web browser is within a sampled and transmitting a first set of usage data indicative of said interaction in the event said first web browser is included within said sampled population wherein said sampled population comprises a subset of a set of web browsers interacting with said content server;
a second client component communicatively coupled to said transmission channel, said second client component determining whether a second user identification code associated with said second web browser indicates that said second web browser is within said sampled population and transmitting a second set of usage data indicative of said interaction in the event said second web browser is included within said sampled population; and
a monitoring sever coupled to said transmission channel, said monitoring server receiving any of said first set of usage data and said second set of usage data respectively transmitted by said first client component and said second client component.

9. The system of claim 8 wherein said first client component determines whether persistent client-side state information stored on said first client computer and associated with said first web browser includes identification information suitable for use as said first user identification code.

10. The system of claim 9 wherein said first client component generates a random number corresponding to said first user identification code in the event said identification information is determined to be unsuitable for use as said first user identification code.

11. The system of claim 8 wherein said first client component includes a first sampling tag and a first data collection script, said first sampling tag requesting said first data collection script to be downloaded from said monitoring server to said first client computer in the event that said first user identification code indicates that said first web browser is included within said sampled population.

12. The system of claim 11 wherein said second client component includes a second sampling tag and a second data collection script, said second sampling tag requesting said second data collection script to be downloaded from said monitoring server to said second client computer in the event that said second user identification code indicates that said second web browser is included within said sampled population.

13. A method for monitoring usage of a web browser during interaction with a content server comprising the steps of:
determining whether a user identification code associated with said web browser indicates that said web browser is included within a subset of a set of web browsers interacting with said content server;
generating usage data indicative of said interaction upon determining that said web browser is within said subset;
transmitting said usage data; and
receiving and storing said transmitted usage data.

14. The method of claim 13 further including the step of storing said user identification code as persistent client-side state information.

15. The method of claim 13 further including the step of determining whether persistent client-side state information associated with said web browser includes identification information suitable for use as said user identification code.

16. The method of claim 15 further including the steps of generating a random number corresponding to said user identification code in the event said identification information is determined to be unsuitable for use as said user identification code, and determining whether said random number indicates that said web browser is included within said subset.

17. A method for monitoring user interaction with a web browser executing on a client computer, said method comprising the steps of:
embedding, within a file, an address of a first server computer;
downloading said file from a second server computer to said client computer;
determining whether a user identification code associated with said web browser indicates that said web browser is within a randomly selected subset of a set of web browsers interacting with said second server computer;
generating usage data indicative of said interaction in the event said web browser is within said randomly selected subset;
transmitting said usage data to said first server computer; and
receiving said usage data at said first server computer and storing said usage data.

18. The method of claim 17 further including the step of storing said user identification code within said client computer as persistent client-side state information.

19. The method of claim 17 further including the step of determining whether persistent client-side state information associated with said web browser includes identification information suitable for use as said user identification code.

20. The method of claim 19 further including the steps of generating a random number corresponding to said user identification code in the event said identification information is determined to be unsuitable for use as said user identification code, and determining whether said random number indicates that said web browser is included within said randomly selected subset.

21. An article of manufacture, which comprises a computer readable medium having stored therein a computer program carrying out a method for monitoring user interaction with a web browser, the computer program comprising:
(a) a first code segment for determining that a user identification code associated with said web browser indicates that said web browser is within a subset of a set of web browsers interacting with a content server;
(b) a second code segment for generating and enabling transmission of usage data indicative of said interaction in the event said web browser is within said subset.

22. The article of manufacture of claim 21 wherein said second code segment includes a third code segment for determining whether persistent client-side state information associated with said web browser includes identification information suitable for use as said user identification code.

23. The article of manufacture wherein said 22 wherein said second code segment includes a fourth code segment for (i) generating a random number corresponding to said user identification code in the event said identification information is determined to be unsuitable for use as said user identification code, and (ii) determining whether said random number indicates that said web browser is included within said subset.
